(19) United States
(12) Patent Application Publication
(10) Pub. No.: US 2013/0239608 A1
(43) Pub. Date: Sep. 19, 2013

(54) SYSTEM AND METHOD FOR SEPARATING COMPONENTS IN A GAS STREAM

(71) Applicant: GENERAL ELECTRIC COMPANY, Schenectady, NY (US)

(72) Inventors: Vitali Victor LISSIANSKI, Niskayuna, NY (US); Laura Michele HUDY, Niskayuna, NY (US); Roger Allen SHISLER, Niskayuna, NY (US); Paul Brian WICKERSHAM, Niskayuna, NY (US); Miguel GONZALEZ, Niskayuna, NY (US); Nikolett SIPOECZ, Niskayuna, NY (US); Doug HOFER, Niskayuna, NY (US)

(73) Assignee: GENERAL ELECTRIC COMPANY, Schenectady, NY (US)

(21) Appl. No.: 13/868,707

(22) Filed: Apr. 23, 2013

Related U.S. Application Data
(63) Continuation-in-part of application No. 13/302,131, filed on Nov. 22, 2011.

(51) Int. Cl. B01D 53/00

(52) U.S. Cl. CPC B01D 53/002
USPC 62/618

(57) ABSTRACT

An incoming compressed gas, such as natural gas, is pre-cooled and the gas separated from any included liquid. The pre-cooled and separated gas is expanded using an expander to rapidly reduce pressure and corresponding temperature, as well as remove any components solidified by the temperature drop. An output stream from the expander, combined with other streams, is again gas/liquid separated. The output separated gas stream is sent through another expansion and gas/liquid separation, separating one or more other components, such that a final output gas is achieved. In the case of natural gas, the final output is, for example, methane, which may be fed back to cool the incoming gas prior to end use of the methane.

### CROSS-REFERENCE TO RELATED APPLICATIONS

This application is a continuation-in-part of U.S. patent application Ser. No. 13/302,131, filed Nov. 22, 2011, and which is incorporated herein by reference in its entirety.

### BACKGROUND

Natural gas (NG) at the well head typically comes in mixtures with other hydrocarbons; principally ethane, propane, butane, and pentanes. In addition, raw natural gas contains water vapor, hydrogen sulfide (H₂S), carbon dioxide (CO₂), helium, nitrogen, and other compounds. The ethane, propane, butane, and pentanes are removed from NG, because they are currently more valuable than NG and can be sold separately. In addition, H₂S currently is removed from NG, because it creates a corrosion problem when NG is transported in a pipeline. Carbon dioxide is an inert component and is removed to increase the energy content of the gas and decrease the energy penalty for NG transportation.

The most common technology to remove H₂S and CO₂ from NG is amine scrubbing. Aside from using chemicals and solvents, this technology requires steam for the amine regeneration and has relatively high energy requirements. The heavy hydrocarbons are removed in a low-temperature distillation process that uses a refrigeration system, adding to the energy requirements.

While the current technology for separating components of natural gas and other gas streams work, there is a need for more “green” gas separation technologies.

### SUMMARY

Briefly, the present invention satisfies the need for separating one or more components from a gas stream without using chemicals or solvents as with amine scrubbing technology, by using multiple stages of expansion of compressed gas to rapidly reduce the pressure and corresponding temperature, resulting in a phase change to enable separation. The back end cooled gas stream can also be fed back to the incoming stream for pre-cooling.

The present invention provides, in a first aspect, a system for separating components from a compressed gas stream. The system includes a first expansion stage, including an expander configured to receive a compressed gas stream, the expander further configured to solidify and/or liquefy at least one first component of the compressed gas stream and to remove solids, the expander having a first expansion output. The system further includes a second expansion stage coupled to the first expansion stage. The second expansion stage includes another expander configured to receive a portion of the first expansion output, the another expander further configured to solidify and/or liquefy at least one second component different from the first component and having a second expansion output.

The present invention provides, in a second aspect, a method of separating one or more components from a compressed gas stream. The method includes providing an input gas stream, the input gas stream being compressed and including a plurality of components, wherein it is desired to separate at least one component of the plurality of components. The method further includes expanding the input gas stream via an expander to decrease a pressure and a temperature thereof, in order to solidify and/or liquefy at least one of the plurality of components, separating by the expander the solidified at least one of the plurality of components from the expanded gas stream, further expanding the expanded gas stream via another expander after the separating in order to solidify and/or liquefy at least one other component of the plurality of components different from the at least one component, and separating the solidified and/or liquefied at least one other component from the further expanded gas stream to leave a remaining gas stream.

These, and other objects, features and advantages of this invention will become apparent from the following detailed description of the various aspects of the invention taken in conjunction with the accompanying drawings.

### BRIEF DESCRIPTION OF THE FIGURES

FIG. 1 is a block diagram of one example of a system for separating components from a gas stream, in accordance with one or more aspects of the present invention.

FIG. 2 is a simplified block diagram of one example of an expander for solid and/or liquid separation from a gas stream, in accordance with one or more aspects of the present invention.

FIG. 3 is a schematic of a cross-sectional view of one example of the expander of FIG. 2, in accordance with one or more aspects of the present invention.

FIG. 4 is a schematic of a cross-sectional view of one example of a multi-stage expander for solid and/or liquid separation from a gas stream, in accordance with one or more aspects of the present invention.

FIG. 5 is a schematic of one example of an expander for solid and/or liquid separation with separation channels, in accordance with one or more aspects of the present invention.

FIG. 6 is a schematic of one example of a heated blade, in accordance with one or more aspects of the present invention.

FIG. 7 is a schematic of another example of a heated blade, in accordance with one or more aspects of the present invention.

FIG. 8 is a schematic of one example of flow path of heating gas in the heated blade of FIG. 7, in accordance with one or more aspects of the present invention.

### DETAILED DESCRIPTION

Aspects of the present invention and certain features, advantages, and details thereof, are explained more fully below with reference to the non-limiting examples illustrated in the accompanying drawings. Descriptions of some well-known materials, components, processing techniques, etc., may be omitted so as not to unnecessarily obscure the present invention in detail. It should be understood, however, that the detailed description and the specific examples, while indicating aspects of the present invention, are given by way of illustration only, and are not by way of limitation. Various substitutions, modifications, additions, and/or arrangements, within the spirit and/or scope of the underlying inventive concepts will be apparent to those skilled in the art from this disclosure.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

The terminology used herein is for the purpose of describing particular examples only and is not intended to be limiting of the present invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

Reference is made below to the drawings, which are not drawn to scale for ease of understanding, some of which include high-level components that omit some detail, again, for ease of understanding. In some cases, those details are provided subsequently, or, if well known, they may be omitted.

At the location of its production, natural gas (NG) typically comes out of the ground in mixtures of methane with other hydrocarbons, water vapor, hydrogen sulfide, carbon dioxide, helium, nitrogen, and other compounds. For example, methane is a desired component of natural gas, as it can be used for fuel for heating, cooking and other purposes. The present invention describes, in one aspect, a method of separating other components from NG to leave the methane. Removal of hydrocarbons, CO₂, and H₂S is achieved by cooling NG via one or more compression and expansion cycles. At low temperatures, heavy hydrocarbons, CO₂ and H₂S, undergo phase transformation and are converted from a gas to a solid or liquid phase for physical separation or filtering, while methane remains in the gas or liquid phase. Cold methane gas resulting can also be fed back to pre-cool the incoming NG after compression and before expansion.

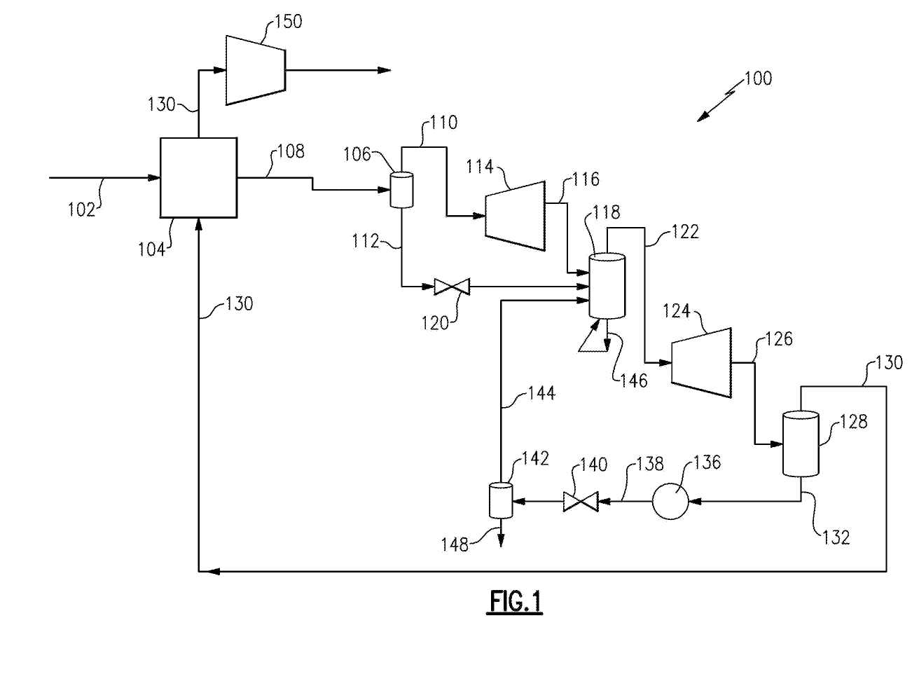

FIG. 1 depicts one example of a system 100 for separating one or more components from a gas stream. In the present example, one or more components in a compressed natural gas stream are removed, in part, using multiple stages of liquid, gas and solid separation at various temperatures achieved by cooling, compression and expansion. In this particular example, carbon dioxide, hydrogen sulfide and heavy hydrocarbons are removed, yielding nearly pure methane. In addition, the methane gas, which is at a low temperature, may be fed back to the incoming natural gas stream for use in a heat exchanger to pre-cool the incoming gas stream.

Returning now to the example of FIG. 1, an incoming dry natural gas stream 102 is fed to a heat exchanger 104, which may be a conventional heat exchanger, for pre-cooling before expansion. The incoming natural gas stream is preferably compressed, but if not, a conventional compression stage (not shown) can be added before or after heat exchanger 104, and prior to flash 106. Typically, the incoming natural gas will be from a pipeline at a temperature of about 50° F. to about 80° F. and a pressure of about 100 psi to about 900 psi. The pre-cooled and compressed natural gas stream 108 is then fed to flash 106, which may be a conventional gas/liquid separator familiar to those skilled in the art. Due primarily to the pre-cooling and high pressure, the stream 108 out of the heat exchanger is a mixture of gas and liquid, though a vast majority thereof remains in a gaseous state. Although the incoming natural gas in this example is from a pipeline, it could instead be directly from a well head, which may not require any compression, as it comes out of the ground naturally compressed to varying degrees, depending on the particular location.

As noted, flash 106 separates compressed and pre-cooled stream 108 into gas 110 and liquid 112. Separated gas 110 from the stream is fed to a first expansion stage including expander 114, which will subsequently be described in detail, but the purpose thereof is to cool the gas by rapid expansion, such that one or more components are solidified and/or liquefied, and are removed by the expander. In practice, however, it will be understood that there may be residual solids and/or liquids in the output of the expander. The term “expander” as used herein refers to a radial, axial, or mixed flow turbo-machine through which a gas or gas mixture is expanded to produce work. Relatedly, the term “expansion stage” refers to an expander that may be coupled with one or more other elements to enhance or compliment separation of one or more components of a stream. Details of the expander are provided below after the description of FIG. 1. It will be understood that any expander of the type described in detail below also includes an outlet for separated solids and/or liquids. Such outlets are omitted in FIG. 1 for clarity.

Although the temperature and pressure decrease in expander 114 has resulted in conversion of some components to solid and liquid phases, still other constituents of the stream remain in the gas stage. Thus, the stream 116 out of expander 114 includes liquid and gas, and is fed to flash 118 for separation thereof. Also fed to flash 118 is the separated liquid stream 112 from flash 106, preferably after running the same through a Joule-Thompson valve 120 or similar. As one skilled in the art will know, such a valve reduces the pressure of the stream 112, resulting in a slight cooling of the same. Additional inputs to flash 118 will subsequently be described.

A separated gas stream 122 from flash 118 is fed to a second expansion stage including expander 124. Expander 124 may be of the same type as expander 114, or, alternatively, may be of a type lacking the feature of solid/liquid removal. This type of expander simply provides expansion. Where additional solid removal is desired, the type of expander 114 would be warranted. As with the first expander, the stream coming into the expander is rapidly expanded in the expander, lowering the pressure and corresponding temperature thereof such that one or more components of the stream change phase to allow separation thereof. In the present example, the temperature is such that methane remains in a gas phase, and carbon dioxide is in a solid phase, while hydrogen sulfide and one or more heavy hydrocarbons (e.g., ethane, propane and butane) are in a liquid phase. The output stream 126 from the second expander 124 is fed to a third flash 128 to separate liquid and any solid present from gas. A vast majority of the separated output gas 130 includes methane, and is fed back to heat exchanger 104. Being at a much lower temperature from the two expanders than the incoming natural gas, the relatively cold methane gas may be used to pre-cool the incoming natural gas prior to expansion. Conventional refrigeration could instead be used for pre-cooling, but is not as energy efficient. After cooling the incoming natural gas stream, the final output gas 130 may be, for example, compressed via conventional compressor 150, prior to collection for end or further use.

As noted, the separated gas 130 includes mostly methane, however, some methane is also present in the separated liquid stream 132 out of flash 128. The purpose of section 134 of system 100 is to recover the liquid methane. A heat exchanger 136, which may be a conventional heat exchanger, is used to warm the separated liquid 132. Warming may cause some components of the separated liquid to revert back to gas. The warmer separated liquid 138 is preferably fed through another Joule-Thompson valve 140, prior to reaching a fourth flash 142 for separating gas from liquid. The separated gas 144 is fed back to the second flash 118, as is the separated liquid 146 out of flash 118 itself. Although constituting a minority portion of the separated liquid 148 from flash 142, the goal of recovering the remaining methane (in a liquid state) is achieved.

Gas temperatures and pressures after expanders 114 and 124 depend on the initial pressure of incoming stream 102, and are typically in the range of about 1 atm to about 5 atm and about −110° C. to about −150° C. after expander 114, and about 0.4 atm to about 1 atm and about −180° C. to about −185° C. after expander 125.

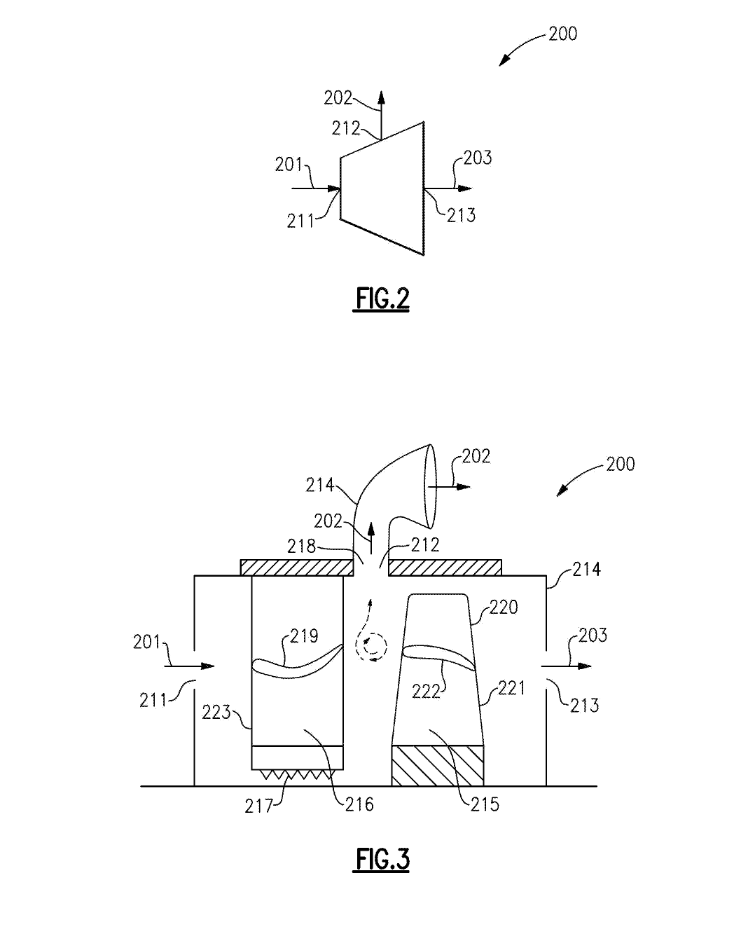

FIG. 2 is a simplified block diagram of one example of an expander 200, in accordance with one or more aspects of the present invention. FIG. 3 is one example of a cross-sectional view of expander 200, in accordance with one or more aspects of the present invention. The description below commonly refers to the expander in both FIGS. 2 and 3.

As indicated in the example of FIG. 3, the expander 200 includes a housing 214. As indicated in FIG. 3, the expander 200 may further include at least one rotating component or a rotor 215. The expander 200 may further include at least one stationary component 216. The stationary component may include a stator or a nozzle. As indicated in FIG. 3, the expander 200 may further include one or more seals 217. As indicated in FIG. 3, the expander 200 may further include one or more blades 219/222, which may be one or more stationary blades 219 and one or more rotor blades 222, respectively.

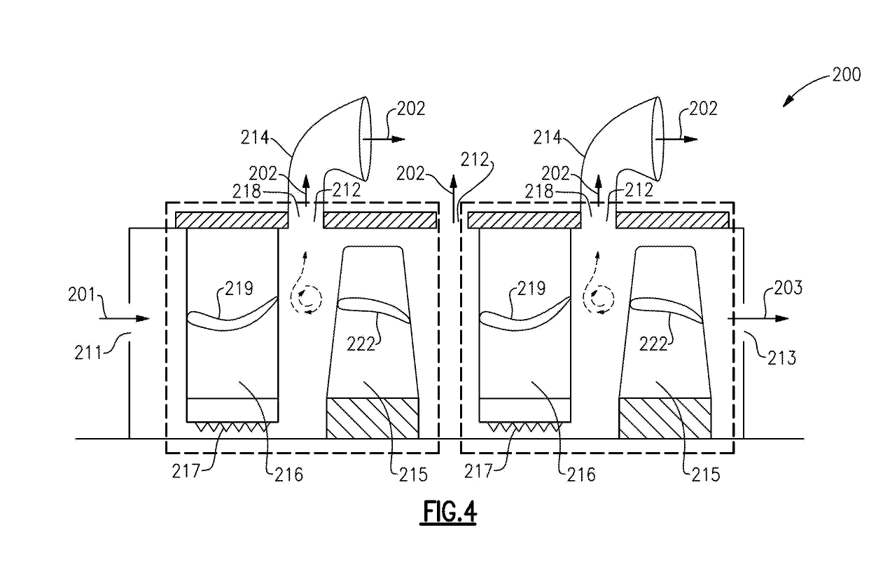

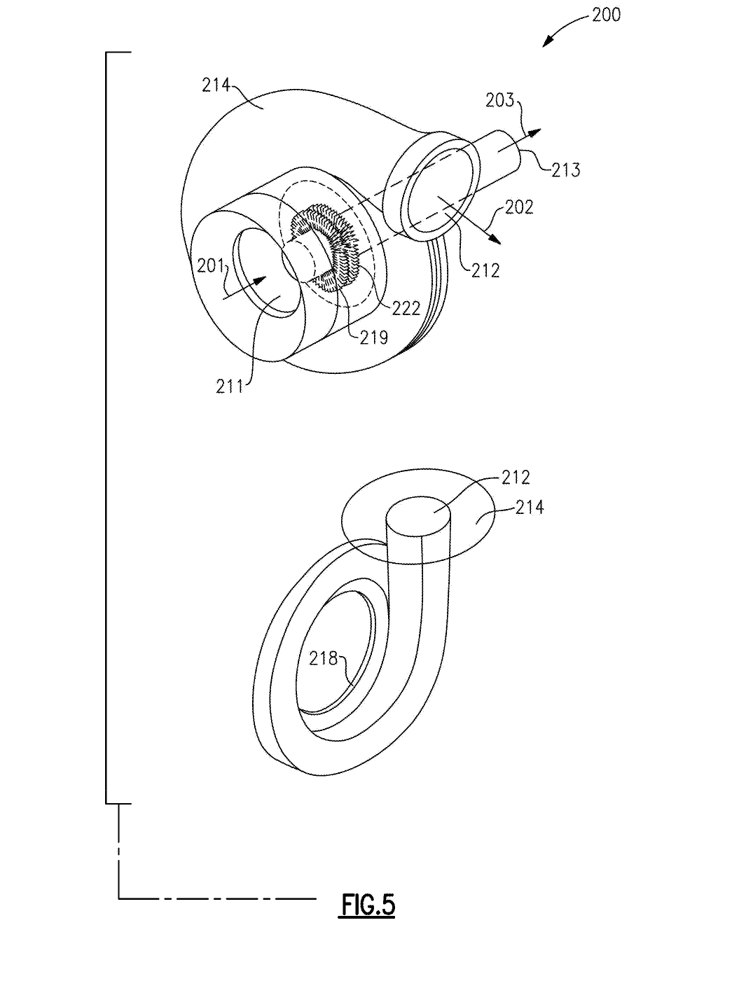

The expander 200 may further include a plurality of outlets 212 and 213, as indicated in FIGS. 2 and 3. As indicated in FIGS. 2 and 3, the expander 200 may further include at least one first outlet 212 configured to discharge a stream 202 of solids and/or liquids after phase change from expansion temperature drop. The housing 214 includes one or more separation channels 218 in fluid communication with the at least one first outlet 212, and configured to separate stream 202 from incoming stream 201. The expander 200 may further include a volute/housing 214 including the one or more separation channels 218 configured to discharge stream 202, as indicated in FIGS. 3-5. The at least one first outlet 212 may be configured to discharge stream 202 through the separation channels 218 present in the housing/volute 214, as indicated in FIGS. 3-5. As indicated in FIGS. 3 and 4, the at least one first outlet 212 may be disposed upstream of the rotating component. The term “upstream” as used herein refers to a location between the stationary component 216 and the rotating component 215. As indicated in FIG. 5, the first outlet 212 may be disposed in the housing 214 at a location between the stationary component 216 and the rotating component 215. Where a multi-stage expander is included, as in FIG. 4, the first outlet may be located upstream of at least one rotating component. Where a plurality of first outlets 212 is included, a first outlet 212 may be located upstream of at least one rotating component 215, as indicated in FIG. 4.

The flow field within the expander 200 may be utilized to aid in separation of solids and/or liquid from gas by incorporating the one or more separation channels 218 into the expander housing 214. In addition, the separation channels 218 may be designed such that the solid and/or liquid particles enter due to centrifugal force, and may be precluded from re-entering the expander flow path by a deflector.

Where configured to separate solids, the incoming stream may include or the separated stream may be made to include one or more carrier gases. For example, where the incoming stream includes CO₂, which is frozen to a solid, the incoming or separated stream may further include, for example, one or more of nitrogen gas, oxygen gas, or carbon dioxide gas, as a carrier gas that may be transported to the first outlet 212 along with the solid CO₂ by centrifugal force.

In one example, at least one component of the expander 200 includes a coating configured to substantially reduce or preclude adhesion of one or more solids to a surface of the expander component. One or more of the housing 214, the rotating component 215, or the stationary component 216, may include such a coating. For example, FIG. 3 depicts rotating component 215 in the expander 200 including such a coating 220 on a surface 221 of the rotating component 215. In one example, the coating 220 includes a non-stick material capable of precluding adhesion of the one or more solids to the surface 221 of the rotating component 215.

In another example, the expander 200 includes at least one heated component configured to preclude adhesion of one or more solids to a surface of the expander component. For example, one or more of the housing 214, the rotating component 215, or the stationary component 216, may include a heated component to preclude adhesion of one or more solids to a surface of the expander component. For example, in FIG. 2, stationary component 216 in the expander 200 may be heated to preclude adhesion of one or more solids to a surface 223 of the stationary component 216.

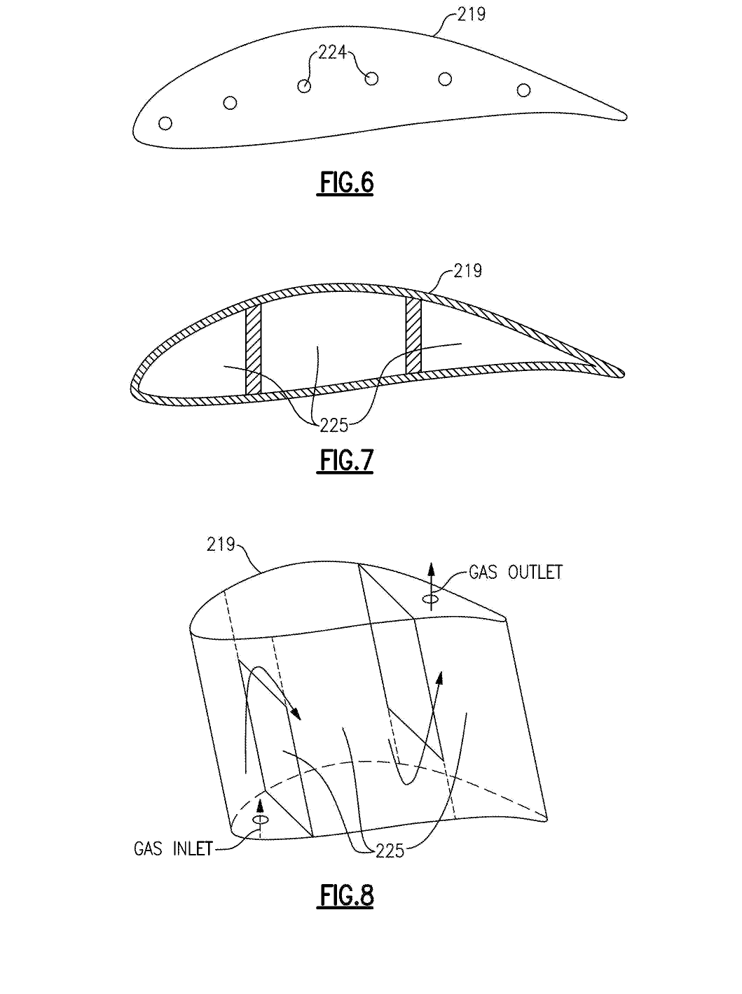

As still another example, one or more of the stationary blades may be heated by using electrical heating elements. FIG. 6 illustrates one example of an electrically heated blade 219. The blade 219, as indicated in FIG. 6, further includes heated elements 224 disposed in holes of the blade 219. As yet another example, one or more components of the expander 200 may be heated by circulating air or gas. FIG. 7 illustrates one example of the present invention, including a blade 219 heated by circulating gas. The blade 219 may further include gas flow channels 225, such as, for example, Z-shaped channels, as indicated in FIG. 7. The gas flow channels may have any suitable shape, such as, for example, U-shape, E-shape, and the like. FIG. 8 further shows an illustrative flow path of the heating gas in the heated blade 219.

As indicated in FIGS. 2 and 3, the expander 200 further includes at least one second outlet 213 configured to discharge a remaining stream 203 after separation from incoming stream 201 of any solids and/or liquids in stream 202. As indicated in FIGS. 3 and 4, the second outlet may be disposed downstream of the rotating component. Where a multi-stage expander is present, as indicated in FIG. 4, the second outlet 213 may be located downstream of at least one rotating component 214. For example, the second outlet 213 may be located downstream of the last rotating component 214 in the expander 200.

As previously noted, the expander 100 for separating one or more solids and/or liquids from a gas stream 201 may include a single-stage expander, as illustrated in FIG. 3 or a multi-stage expander 200, as illustrated in FIG. 4. The multi-stage expander may include a plurality of stationary components 216 and a plurality of rotating components 215. Further, the multi-stage expander 200 may be configured to include a plurality of first outlets 212. As indicated in FIG. 4, the plurality of first outlets 212 may be configured to discharge a plurality of solid and/or liquid streams 202 at different stages of the multi-stage expander 200. The multi-stage expander 200 may further include at least one second outlet 213, as indicated in FIG. 4.

### Example

In one example, using the system of FIG. 1, an incoming natural gas stream 102 has a temperature of about 25° C., a pressure of about 200 bar, and is included of about 81.55% (i.e., 0.8155 mole fraction) methane (CH₄), along with about 4.07% carbon dioxide (CO₂), about 2.55% hydrogen sulfide (H₂S) and various other components as previously noted. After passing through heat exchanger 104, the temperature of the stream has dropped to about −32.8° C., while the pressure and phase remain the same. After gas/liquid separation in flash 106, the gas 110 has a temperature of about −74.7° C. and a pressure of about 36.5 bar. Expander 114 has a significant effect, rapidly lowering the pressure to about 3 bar, which causes the temperature to drop to about −144.7° C. In addition, while any solids (here, CO₂) have been removed by the expander, as described previously, the remainder of the stream 116 out of the expander is a combination of about 85.7% gas and about 14.3% liquid. This combination stream is then sent to flash 118, along with other streams in the system.

The gas stream 122 separated by flash 118 has a temperature of about −135.5° C. and a pressure of about 3 bar. At this point, the gas stream 122 is about 96% methane. After the second expander 124, the output 126 has become a mixture of gas and liquid, about 93.6% and 6.4%, respectively, due to expansion further dropping the pressure to about 1 bar and the temperature to about −161.1° C. If expander 124 is of the same type as expander 114, then H₂S and additional CO₂ are solidified and removed. The portion of the stream out of the second expander that is methane has increased slightly to about 97%. The combination stream is again separated in flash 128, and the gas output 130 has increased slightly to about −141.4° C. and 1.8 bar, while the fraction of methane remains about the same.

The liquid 132 out of flash 128 remains at a temperature of about −161.1° C. and a pressure of about 1 bar. As noted above, the purpose of section 134 of heat exchanger 136, valve 140 and flash 142 is to remove as much of the liquid methane as possible. Accordingly, heat exchanger 136 raises the temperature of the stream 138 to about −90° C. and a pressure of about 20 bar. Raising the temperature and pressure results in almost a complete phase change from liquid to gas, with only about 0.02% remaining as liquid. After JT valve 140, the stream has a temperature of −112.8° C., a pressure of 3 bar, and is now fully in the gas phase. The gas 144 out of flash 142 has the same characteristics as prior to the flash, however, the liquid 148 has a temperature of about −74.7° C. and a pressure of about 36.5 bar. The liquid is about 61% methane. The gas out of flash 142 is fed into flash 118, as is the stream exiting JT valve 120, which has a temperature of about −126.2° C. and a pressure of about 3 bar. The stream exiting JT valve 120 is an almost equal mixture of gas and liquid. After being fed back to heat exchanger 104 for cooling the incoming stream, the final methane stream 130 has a temperature of about 10° C. and a pressure of about 1.8 bar. The methane remains at about 97% of the final stream. Optionally, the final stream may be compressed in compressor 150 (e.g., for transport) to a pressure of about 30 bar, also raising the temperature to about 25° C.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the present invention has been described in detail in connection with only a limited number of embodiments, it should be readily understood that the present invention is not limited to such disclosed embodiments. Rather, the present invention can be modified to incorporate any number of variations, alterations, substitutions or equivalent arrangements not heretofore described, but which are commensurate with the spirit and scope of the present invention. Additionally, while various embodiments of the present invention have been described, it is to be understood that aspects of the disclosure may include only some of the described embodiments. Accordingly, the present invention is not to be seen as limited by the foregoing description, but is only limited by the scope of the appended claims.

This written description uses examples to disclose the present invention, including the best mode, and also to enable any person skilled in the art to practice the present invention, including making and using any devices or systems and performing any incorporated methods. The patentable scope of the present invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for separating components from a compressed gas stream, the system comprising:
a first expansion stage, comprising an expander configured to receive a compressed gas stream, the expander further configured to solidify and/or liquefy at least one first component of the compressed gas stream and to remove solids, the expander having a first expansion output;
a second expansion stage coupled to the first expansion stage, comprising another expander configured to receive a portion of the first expansion output, the another expander further configured to solidify and/or liquefy at least one second component different from the first component and having a second expansion output.

2. The system of claim 1, further comprising:
a first separator to separate liquid from gas in an incoming compressed gas stream, wherein the compressed gas stream received by the first expansion stage comprises a separated gas stream from the first separator;
a second separator to separate liquid from gas in an input stream, the input stream comprising the first expansion output and a separated liquid stream from the first separator;
a third separator to separate liquid from gas in an input stream, the input stream comprising the second expansion output.

3. The system of claim 2, further comprising a heat exchanger to cool the incoming gas stream prior to the first separator.

4. The system of claim 3, wherein a separated gas stream from the third separator is fed back to the heat exchanger for cooling the incoming compressed gas stream.

5. The system of claim 4, wherein the incoming gas stream comprises compressed natural gas, and wherein a separated gas stream from the third separator comprises methane.

6. The system of claim 2, further comprising a Joule-Thompson valve between the first separator and the second separator.

7. The system of claim 2, wherein a separated liquid stream from the second separator is fed back to the second separator.

8. The system of claim 2, further comprising:
another heat exchanger for warming a separated liquid stream from the third separator; and
a fourth separator to separate liquid from gas in the warmed stream, wherein a separated gas stream from the fourth separator is fed as an input to the second separator.

9. The system of claim 8, further comprising a Joule-Thompson valve between the another heat exchanger and the fourth separator.

10. The system of claim 8, wherein the incoming gas stream comprises compressed natural gas, and wherein a separated liquid stream from the fourth separator comprises liquid methane.

11. A method of separating one or more components from a compressed gas stream, the method comprising:
providing an input gas stream, the input gas stream being compressed and comprising a plurality of components, wherein it is desired to separate at least one component of the plurality of components;
expanding the input gas stream via an expander to decrease a pressure and a temperature thereof, in order to solidify and/or liquefy one or more of the plurality of components;
separating by the expander the solidified one or more components of the plurality of components from the expanded gas stream;
further expanding the expanded gas stream via another expander after the separating in order to solidify and/or liquefy at least one other component of the plurality of components different from the at least one component; and
separating the solidified and/or liquefied at least one other component from the further expanded gas stream to leave a remaining gas stream.

12. The method of claim 11, wherein the providing comprises pre-cooling the input gas stream prior to the expanding.

13. The method of claim 12, wherein pre-cooling the input gas stream comprises passing the input gas stream through a heat exchanger.

14. The method of claim 13, wherein the passing comprises feeding the remaining gas stream back to the heat exchanger for the pre-cooling.

15. The method of claim 11, wherein separating the solidified and/or liquefied at least one other component is performed by the another expander.

16. The method of claim 11, further comprising:
separating gas from liquid in the input gas stream prior to the expanding, wherein expanding the input gas stream comprises expanding the separated gas;
separating gas from liquid in a combination stream, the combination stream comprising the expanded separated gas and the liquid separated from the input gas stream, wherein the further expanding comprises expanding gas separated from the combination stream; and
separating gas from liquid in the further expanded gas stream, wherein the separated gas comprises the remaining gas stream after separating the solidified and/or liquefied at least one other component.

17. The method of claim 16, further comprising:
warming the separated liquid stream from the expanded separated gas stream by passing it through another heat exchanger;
separating gas from liquid in the warmed liquid stream separated from the further expanded gas stream;
feeding the separated gas from the further expanded gas stream to the combination stream; and
collecting the separated liquid from the warmed separated gas stream.

18. The method of claim 17, wherein the input gas stream comprises natural gas, wherein the one or more components of the plurality of components comprises carbon dioxide, wherein the at least one other component of the plurality of components comprises at least one of hydrogen sulfide and a hydrocarbon, and wherein the collected liquid comprises methane.
